(19) United States
(12) Patent Application Publication
(10) Pub. No.: US 2004/0085334 A1
(43) Pub. Date: May 6, 2004

(54) System and method for creating and displaying interactive computer charcters on stadium video screens

(76) Inventor: Mark Reaney, Lawrence, KS (US)

Correspondence Address: Mark David Reaney, 2700 Meadow Place, Lawrence, KS, 66047, US

(21) Appl. No.: 10/283,961

(22) Filed: Oct. 30, 2002

(51) Int. Cl. G09G 5/00

(52) U.S. Cl. 345/706; 345/728

(57) ABSTRACT

A system and method are provided for creating and displaying interactive computer characters on sports stadium and arena video screens. A virtual character or avatar is create by a computer and controlled by the computer's joystick and keyboard. Further control is provided by a voice activated device attached to the computer's joystick. This device allows the operator to control specific-functions, such as moving the avatar's mouth, by speaking into the microphone. The video output of the computer is then displayed on the extremely large video screen of a sports stadium or arena. The display of the avatar can be enhanced by superimposing it over a live video picture of fans in the venue, captured by a video camera.

### BACKGROUND OF THE INVENTION

The current invention relates to the field of computer graphics and visual display systems. It is further related to virtual characters or avatars (e.g., animated persons) wherein information is given via a metaphorical image. The current U.S. patent classification for this type of system may fall under 345/706.

This invention is an improvement on previous interactive avatar systems. These systems are operated by a user who remains hidden from sight and present an avatar on a computer monitor to a participant who speaks or interacts directly with the image on the screen. The virtual character appears on the screen and the participant remains in front of it and the two interact face to face. Such systems are typically used at trade-shows or at public relations events.

Interactive avatars are also found in many computer games. In this case the participant is the operator/user. Again, these avatars are presented on computer monitors while the user remains outside it. Typically the avatar reacts to the user's input without overtly acknowledging the user's presence. Instead, it is seemingly aware of only the elements of the game.

### SUMMARY OF THE INVENTION

The current invention is a system that combines several software and hardware elements to construct a different interaction between the user, the avatar and the participant. This unique interaction is more suitable to the very large number of participants present at a sporting event

This invention displays an avatar on large video screens found in sports arenas and stadiums. Additionally, by superimposing the avatar over a live picture from a video camera, it is possible for the avatar to appear on the video screen coincidentally with views of the fans or athletes in the venue. In this way the fans can see the avatar and themselves simultaneously. Because the actions of the avatar are controlled in real time, similar to an electronic puppet, the operator can cause the avatar to seemingly react to actions of the fans. If they wave, the avatar can wave. When they dance, the avatar dances.

The system has several elements. A computer contains files that define the 3d computer model that gives form to the avatar. Software is required to provide instructions for the avatar's movement. Manual input devices are connected to the computer to control the avatar. A joystick controls the major body and head movements. Pressing keys on a keyboard trigger the start of specialized movements such as the waving of an arm of winking an eyelid.

The joystick is improved with the addition of a voice-activated switch. Speaking into a microphone connected to this switch has an effect similar to pressing one of the joysticks buttons. This, in turn, opens and closes the mouth of the avatar in synchronization with the operator's voice. If the avatar has no mouth, the voice-activated feature can be used to trigger other actions.

The video output of the computer is filtered through a converter to render it in a video format suitable for display on a stadium or arena video screen. In order to superimpose the avatar's image over live pictures of the fans, at least one video camera is needed to capture those pictures. The camera picture and the video output from the computer are combined with a video switcher/mixer device and finally displayed on the large stadium video screen.

### DESCRIPTION OF THE DRAWINGS

FIG. 1 is a block diagram of a system that is suitable for practicing a preferred embodiment of the present invention.

FIG. 2 is a diagram of a video presentation rendered by the present invention FIG. 3 is a diagram of the voice-activated switch that can be added to the joystick

### DETAILED DESCRIPTION

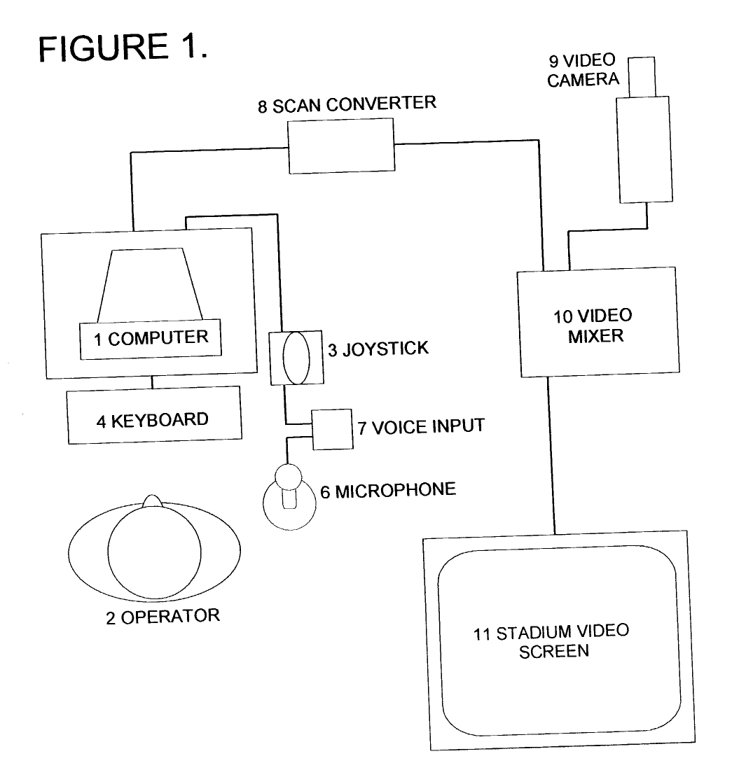

A system and method for creating and displaying interactive computer characters on stadium video screens is described. FIG. 1 is a block diagram of a system for manipulating an avatar and displaying it on a stadium or arena video screen. The computer (I) contains and runs the software required to generate a virtual character, or avatar. Generally, an operator (2) may manually manipulate one or more input devices in order to cause the avatar to move. The joystick (3) causes the avatar to bend forward, backward and to either side. Pressing keys on the keyboard (4) causes the avatar to perform various complex actions such as waving or jumping up and down. Moving the mouse (5) adjusts the view of the avatar, moving it to either side of the screen, enlarging or reducing its apparent size.

A microphone (6) is connected to a voice input device (7). This device consists of a voice-activated switch and a relay connected to one button of the joystick (3). The particular button controls the movement of the avatar's mouth. By pressing the button or by speaking into the microphone, the avatar's mouth can be made to move in a fashion that simulates the action of speaking.

The video output of the computer (1) is changed video signal compatible with a stadium scoreboard by a scan converter (8). This scan converter may be internal to the computer or an external component. The converted video output is conducted to a video mixer (10) that allows an operator to select one of various video sources to be displayed on the stadium or arena video screen (11). This video mixer also has the capability to perform a chroma-key operation in which the view of the avatar can be superimposed over other video sources, most notably pictures of attending sports fans captured by a video camera (9).

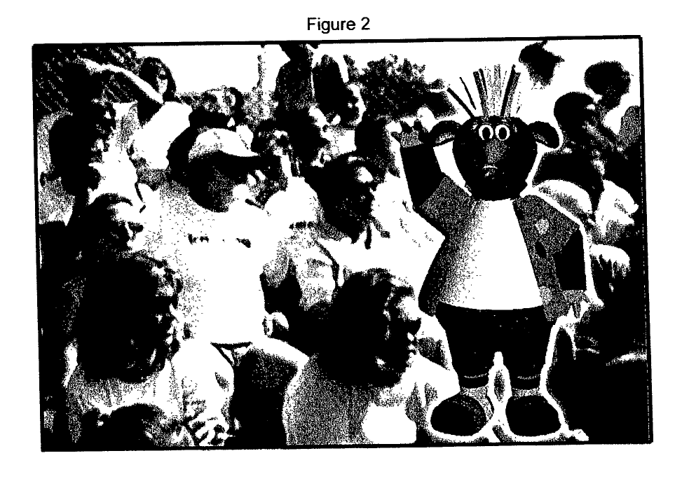

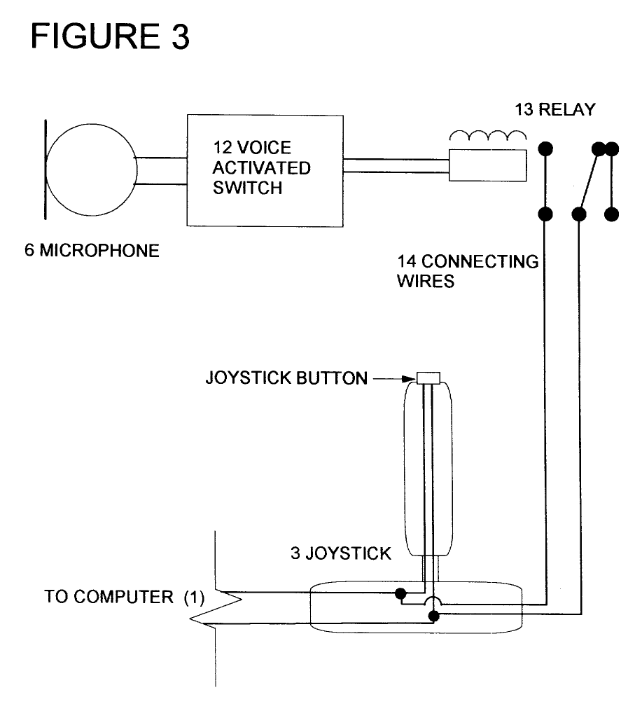

FIG. 2 shows a representative illustration of an avatar superimposed over a live video picture of sports fans. In order to successfully create a chroma-key superimposition the avatar must be rendered with a brightly colored background. This background can then be replaced with a live camera video picture by means of the video mixer.

FIG. 3 is a diagram of the voice input device.

When the operator speaks into the microphone (6) the voice-activated switch (12) is activated, sending a current to the relay (13) and closing the relay's contact switch. The terminals of the relay are connected through wires (14) to the contacts of one of the joystick's (3) buttons. Therefore, closing the relay has the same effect as pressing a joystick button. Therefore, by speaking into the microphone, the operator can manipulate the avatar n the same way one would by pressing a button of the joystick.

I claim:

1. A system and method for creating and displaying interactive computer characters on sports stadium and arena video screens comprising
a computer apparatus having a visual display device, manual input devices and a computer program wherein said computer program, when implemented on said computer,
displays on said display device a computer graphic character which can be manipulated by the manual operation of said input devices,
a sports stadium or arena video screen of sufficient size to be viewed simultaneously by a majority of the stadium or arena's spectators to which the video output of said computer apparatus is connected and whereby said computer graphic character is displayed.

2. The system and method of claim 1 in which said manual input devices are comprised of a joystick, the moving of which causes said computer character to bend and gesture accordingly and a keyboard wherein the pressing of certain keys causes said computer character to move according to predefined actions, whereby the physical behavior of said compute character can be controlled spontaneously by a computer operator.

3. The system and method of claim 2 including a video camera and a video mixer wherein the video mixer superimposes the image of said computer character over a live video picture of sports fans captured by said video camera whereby said fans can view themselves in composite with said computer character on said stadium or arena video screen.

4. The system and method of claim 3 including an input device comprising a microphone and a circuit consisting of a voice-activated switch and a relay and connecting said microphone to said joystick, wherein said computer operator can speak into said microphone with the effect of pushing one of the control buttons of said joystick, whereby said computer operator can control one or more functions of said computer character by speaking into said microphone.
